(19) United States
(12) Patent Application Publication
(10) Pub. No.: US 2026/0054683 A1
(43) Pub. Date: Feb. 26, 2026

(54) HYBRID INFLATOR

(71) Applicant: TOYODA GOSEI CO., LTD., Kiyosu-shi (JP)

(72) Inventors: Ken YAMAMOTO, Aichi-ken (JP); Yoshio ONO, Aichi-ken (JP); Keisuke MORI, Aichi-ken (JP); Hisashi TSUJIMOTO, Aichi-ken (JP)

(21) Appl. No.: 19/294,854

(22) Filed: Aug. 8, 2025

(30) Foreign Application Priority Data
Aug. 23, 2024 (JP) 2024-143265

(51) Int. Cl. B60R 21/272; B60R 21/274

(52) U.S. Cl. CPC B60R 21/272; B60R 21/274

(57) ABSTRACT

A hybrid inflator has a cylindrical bottle filled with a pressurized gas, a propellant storage portion including a housing disposed on one end side of the bottle and storing a propellant to be ignited in operation inside the housing, and a gas discharge port portion disposed on the other end side of the bottle to allow the pressurized gas to be discharged. The propellant storage portion is partitioned from the bottle by a propellant-side burst disk. The gas discharge port portion is partitioned from the bottle and closed by a discharge port-side burst disk. The propellant-side burst disk is joined to an end surface of the housing. A reinforcement plate is disposed to face a surface of the propellant-side burst disk on a side opposite to the housing. The reinforcement plate has an opening smaller in diameter than a region surrounded by the annular joint portion.

### CROSS-REFERENCE TO RELATED APPLICATIONS

This application is based on and claims priority under 35 USC 119 from Japanese Patent Application No. 2024-143265 filed on Aug. 23, 2024, the entire content of which is incorporated herein by reference.

### TECHNICAL FIELD

The present disclosure relates to a hybrid inflator that is used in an airbag device mounted on an automobile or the like and supplies a pressurized gas to an airbag or the like in operation.

### BACKGROUND ART

For example, as described in JP2023-061712A below, a hybrid inflator that is used in an airbag device mounted on an automobile or the like and supplies a pressurized gas to an airbag or the like in operation includes a substantially cylindrical bottle filled with the pressurized gas, a propellant storage portion provided on one end side of the bottle, and a gas discharge port portion provided on the other end side of the bottle, and ruptures a propellant-side burst disk that partitions the propellant storage portion and the bottle by a pressure increase in the propellant storage portion due to a combustion gas generated when the propellant is ignited, and then ruptures a discharge port-side burst disk that partitions the bottle and the gas discharge port portion by a pressure increase of the pressurized gas in the bottle heated by the combustion gas, and discharges the pressurized gas from the gas discharge port portion.

In the hybrid inflator configured as described above, as the size of the vehicle increases, the capacity of the airbag also becomes larger, which requires an increased amount of the pressurized gas used as an inflation gas supplied to the airbag. However, when the amount of the pressurized gas filled in the bottle increases, the time required for the temperature rise of the pressurized gas and the rupture of the discharge port-side burst disk increases, and thus it is required to improve the discharge of the pressurized gas in terms of quickness.

### SUMMARY

An object of the present disclosure is to provide a hybrid inflator that is capable of quickly discharging a pressurized gas.

An aspect of the present disclosure provides a hybrid inflator having:
a bottle having a cylindrical shape and filled with a pressurized gas;
a propellant storage portion including a housing disposed on one end side of the bottle, and configured to store a propellant to be ignited in operation inside the housing, the propellant storage portion being partitioned from the bottle by a propellant-side burst disk configured to close a gas outflow port provided in the housing; and
a gas discharge port portion disposed on an other end side of the bottle to allow the pressurized gas to be discharged, the gas discharge port portion being partitioned from the bottle and closed by a discharge port-side burst disk, in which
the propellant-side burst disk is joined at an annular joint portion to an end surface of the housing, the annular joint portion surrounding the gas outflow port, and
a reinforcement plate is disposed to face a surface of the propellant-side burst disk on a side opposite to the housing, the reinforcement plate having an opening smaller in diameter than a region surrounded by the annular joint portion.

According to the hybrid inflator configured as described above, the opening small in diameter is provided in the reinforcement plate disposed so as to face the propellant-side burst disk, and when the ignited propellant generates a combustion gas, the pressure rise due to the combustion gas on a housing side causes the opening on the reinforcement plate to rupture by the opening diameter. In a case in which the reinforcement plate is not provided, a pressure receiving surface of the propellant-side burst disk on which the pressure of the combustion gas from the housing side acts is a region surrounded by an annular joint portion, whereas according to the present disclosure, the pressure receiving surface of the propellant-side burst disk is a region corresponding to the opening small in diameter provided on the reinforcement plate (opening smaller in diameter than a region surrounded by the annular joint portion), and an area of the pressure receiving surface in the propellant-side burst disk is reduced. As a result, in the hybrid inflator according to the present disclosure, a rupture pressure is increased, and a shock wave generated upon rupturing can be increased. Then, the discharge port-side burst disk can be quickly ruptured by the increased shock wave. Therefore, in the hybrid inflator according to the present disclosure, the pressurized gas in the bottle can be quickly discharged after the propellant is ignited.

Here, from the viewpoint of reducing the area of the pressure receiving surface of the propellant-side burst disk, the opening of the reinforcement plate may have a smaller diameter than the gas outflow port.

Further, in the hybrid inflator according to the present disclosure, the propellant-side burst disk can be disposed in the step-down attachment seat formed on the end surface of the housing from the viewpoint of improving assemblability. In this case, a surface of the reinforcement plate facing the propellant-side burst disk may have a stepped shape, and a central portion corresponding to the attachment seat of the housing may protrude.

In this way, the relative positions of the concave attachment seat and the convex central portion of the reinforcement plate are adjusted by engagement therebetween, and therefore the assemblability of the reinforcement plate can be improved. Further, the reinforcement plate can be disposed close to the propellant-side burst disk disposed on the step-down attachment seat, and when the combustion gas is generated, the reinforcement plate can quickly abut against the propellant-side burst disk to rupture the propellant-side burst disk.

### BRIEF DESCRIPTION OF DRAWINGS

Exemplary embodiment(s) of the present invention will be described in detail based on the following figures, wherein:

FIG. 1 is a schematic cross-sectional view of a hybrid inflator according to one embodiment of the present disclosure;

FIG. 2 is an enlarged view of one end side of a bottle illustrated in FIG. 1;

FIG. 3 is a diagram illustrating a gas generator and a housing constituting a propellant storage portion illustrated in FIG. 2;

FIG. 4 is a diagram illustrating a reinforcement plate illustrated in FIG. 2 alone;

FIG. 5 is a diagram illustrating operations and effects of the same embodiment;

FIG. 6 is an enlarged view of the other end side of the bottle illustrated in FIG. 1; and FIG. 7 is a diagram illustrating a modification in which a shape of the reinforcement plate is changed.

### DESCRIPTION OF EMBODIMENTS

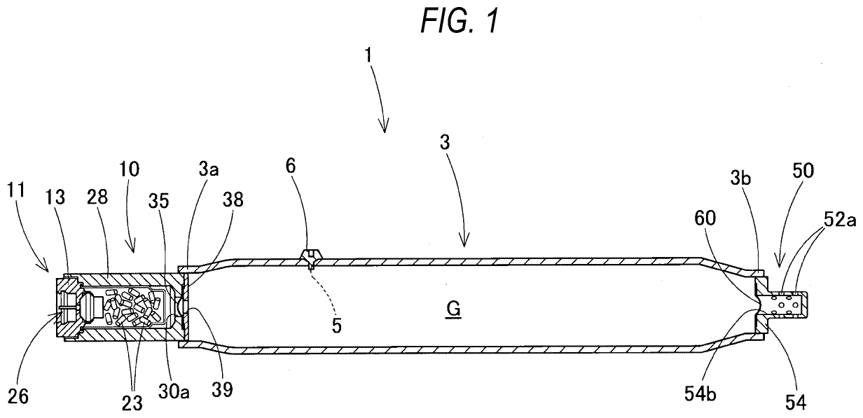

Hereinafter, one embodiment of the present disclosure will be described with reference to the drawings. As illustrated in FIG. 1, a hybrid inflator 1 according to the present embodiment includes a bottle 3 having a substantially cylindrical shape and filled with a pressurized gas G, a propellant storage portion 10 disposed on one end (end portion 3a) side of the bottle 3, and a gas discharge port portion 50 disposed on the other end (end portion 3b) side of the bottle 3. The propellant storage portion 10 is partitioned from the bottle 3 by a propellant-side burst disk 35, and the gas discharge port portion 50 is partitioned from the bottle 3 by a discharge port-side burst disk 60.

The bottle 3 has a substantially cylindrical shape with both ends opened and a substantially constant thickness, and is filled with the pressurized gas G. A filling opening 5 for filling the inside with the pressurized gas G is formed at a predetermined position of the bottle 3. The filling opening 5 is sealed by a sealing pin 6.

The propellant storage portion 10 disposed on the one end (end portion 3a) side of the bottle 3 includes a gas generator 11 and a housing 28 that stores and holds the gas generator 11.

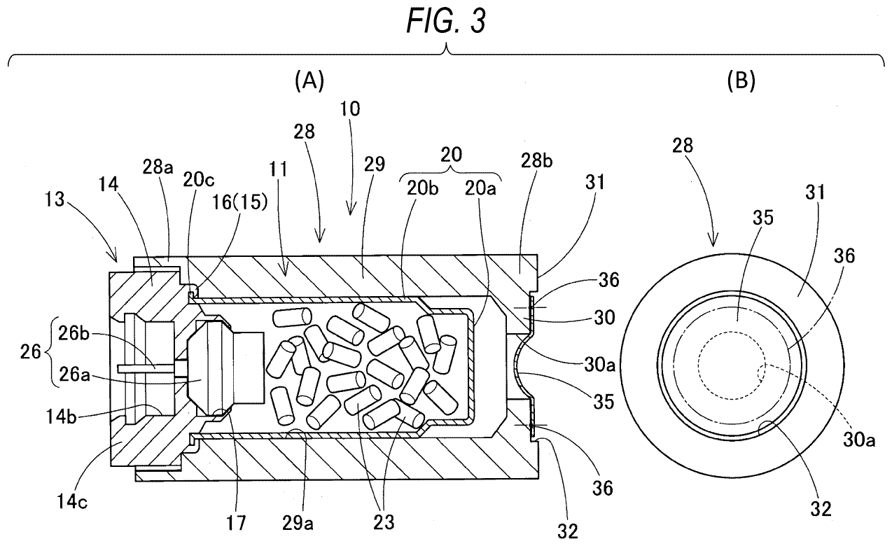

As illustrated in FIG. 3, the gas generator 11 includes a squib 26 held by a holder 13, a propellant 23 that is to be ignited by the squib 26 to generate a combustion gas, and a cup 20 that stores the propellant 23 and is attached to the holder 13.

The propellant 23 is formed in a predetermined shape (in the case of the present embodiment, a substantially columnar shape) and is filled in the cup 20.

The cup 20 is made of a metal such as an aluminum alloy that can be broken (exploded) when the combustion gas of the propellant 23 is generated, and includes a ceiling portion 20a and a cylindrical peripheral wall portion 20b extending from a peripheral edge of the ceiling portion 20a to a holder 13 side, and an end portion 20c of the peripheral wall portion 20b is caulked and coupled to a cup coupling portion 16 of the holder 13. The cup 20 is unnecessary when the propellant 23 is directly filled into the housing 28.

The squib 26 includes an ignition portion 26a having a substantially truncated cone shape and two electrode pins 26b extending from the ignition portion 26a. In the squib 26, when an operation current flows through the electrode pin 26b, an ignition charge (not illustrated) in the ignition portion 26a is ignited to generate a flame, and the propellant 23 is ignited by the flame.

As illustrated in FIG. 3, the holder 13 is made of a metal such as steel or an aluminum alloy, and includes a substantially cylindrical tubular portion 14 and a ceiling portion 15 disposed on a distal end side of the tubular portion 14. The ceiling portion 15 is provided with the cup coupling portion 16 to which the end portion 20c of the cup 20 is coupled. A squib housing portion 17 that stores and holds the ignition portion 26a of the squib 26 is disposed inside the cup coupling portion 16. On an inner peripheral surface 14b side on a bottom surface 14c side of the tubular portion 14, a concave portion into which a connector (not illustrated) to be coupled to the electrode pin 26b of the squib 26 is fitted is disposed.

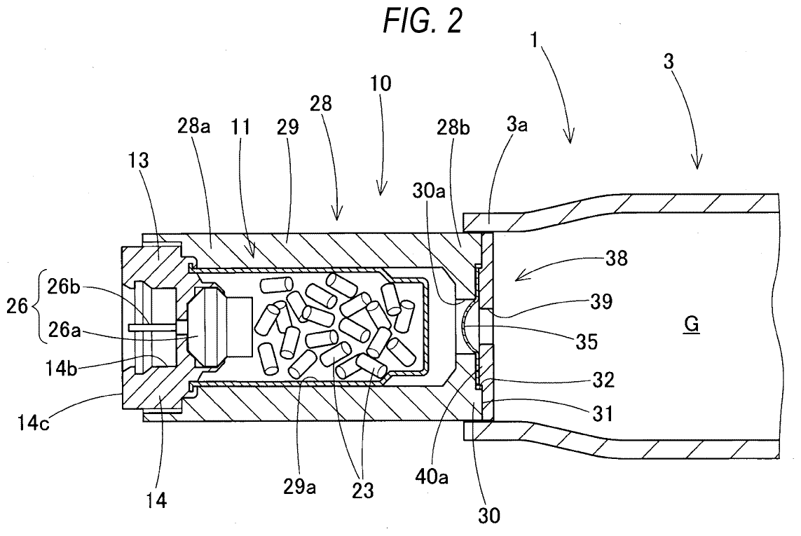

The housing 28 is formed in a substantially cylindrical shape made of a metal such as steel, and is disposed with a bottom portion 28a side protruding from the bottle 3 and a distal end portion 28b side inserted into the bottle 3 (see FIG. 2). As illustrated in FIG. 3, the housing 28 includes a cylindrical peripheral wall portion 29 having an opening on the bottom portion 28a side, and a ceiling portion 30 disposed at the distal end portion 28b. An inner peripheral side of the peripheral wall portion 29 is a storage recess 29a that stores the gas generator 11. The ceiling portion 30 is provided with a gas outflow port 30a.

The gas outflow port 30a allows the combustion gas ejected from the gas generator 11 to flow out into the bottle 3, and is provided with the propellant-side burst disk 35 having a thin circular plate shape and made of a breakable metal such as a nickel-based alloy so as to prevent the pressurized gas G sealed in the bottle 3 before the combustion gas flows out from flowing back toward the housing 28.

Specifically, a step-down attachment seat 32 is formed on an end surface 31 facing a bottle 3 side around the gas outflow port 30a, and the propellant-side burst disk 35 is disposed in the concave attachment seat 32. As indicated by a one-dot chain line in (B) of FIG. 3, an annular joint portion 36 surrounding the gas outflow port 30a is formed by laser welding in the vicinity of a peripheral edge portion of the propellant-side burst disk 35, and the propellant-side burst disk 35 is joined to the end surface 31 (specifically, the attachment seat 32) of the housing 28 so as to airtightly close the gas outflow port 30a.

As illustrated in FIG. 2, the housing 28 configured as described above is press-fitted so that an outer peripheral surface side thereof abuts against an inner peripheral surface of the end portion 3a of the bottle 3 in a state of storing and holding the gas generator 11, and is fixed by laser welding or the like. In an assembled state, the propellant-side burst disk 35 receives the pressure of the pressurized gas G and is curved in a convex shape toward the housing 28 at a portion overlapping the gas outflow port 30a.

Here, in the present embodiment, as illustrated in FIG. 2, a reinforcement plate 38 is disposed so as to face a surface of the propellant-side burst disk 35 opposite to the housing 28. The reinforcement plate 38 is a member for partially restricting the movement of the propellant-side burst disk 35 until the propellant-side burst disk 35 receives the pressure of the combustion gas from the housing 28 side and ruptures when the combustion gas is generated, and increasing the shock wave generated upon rupturing.

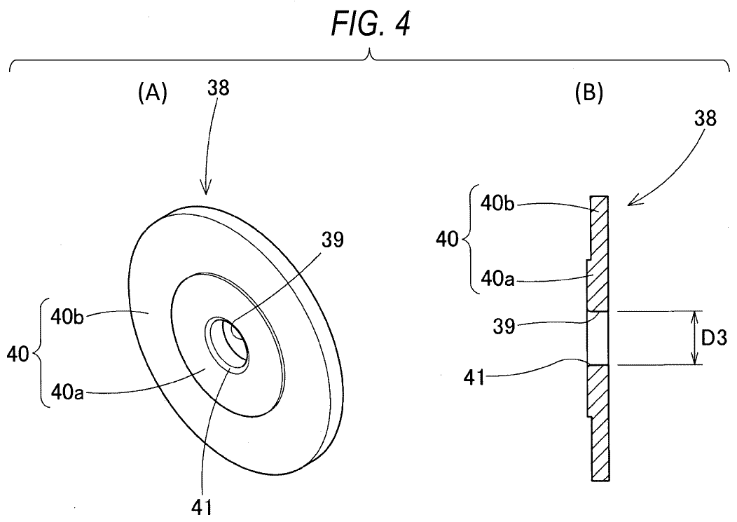

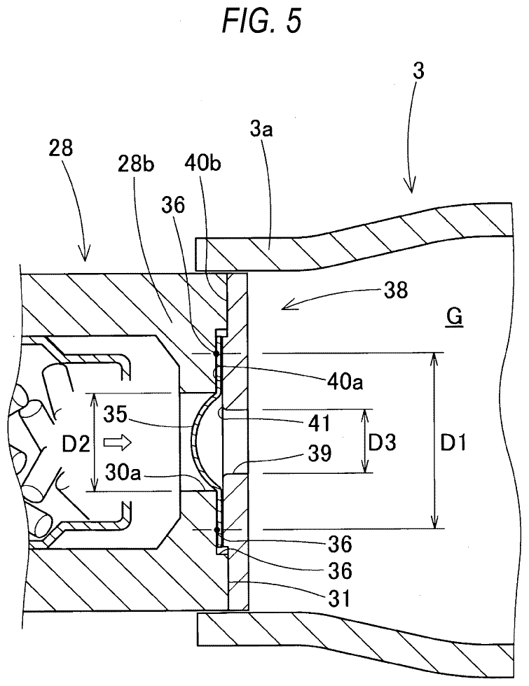

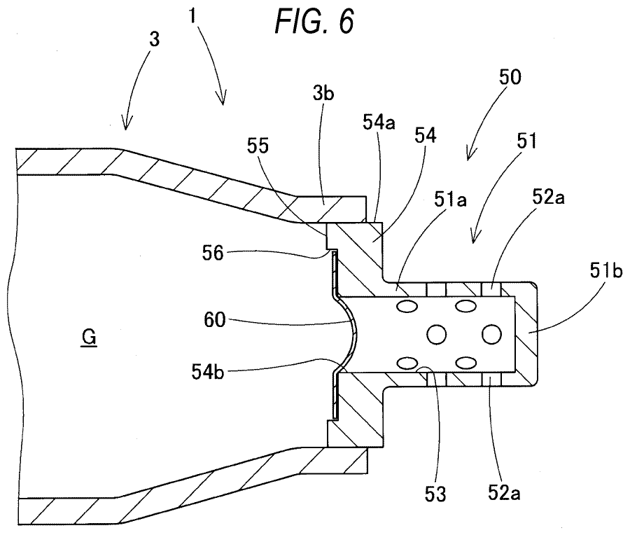

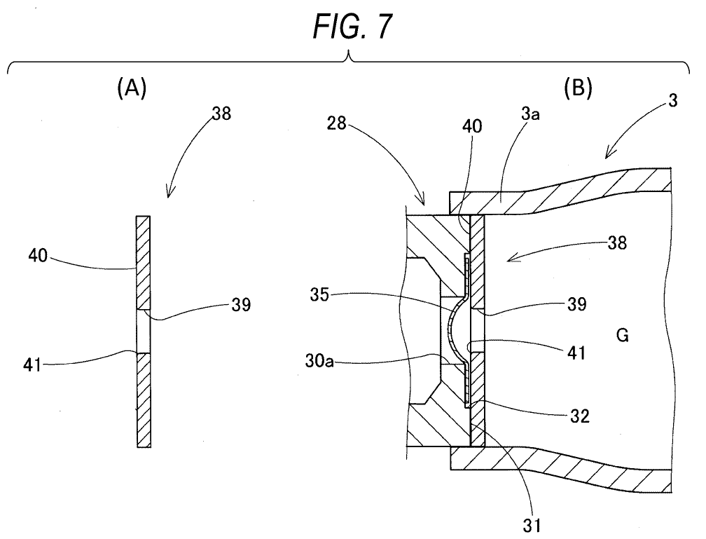

FIG. 4 is a diagram illustrating the reinforcement plate 38 alone. The reinforcement plate 38 is a metal circular plate-shaped member having substantially the same outer diameter as an inner diameter of the end portion 3a of the bottle 3, and an opening 39 penetrating in a plate thickness direction is formed in a center portion thereof. As illustrated in FIG. 5, a diameter D3 of the opening 39 is smaller than a diameter D1 of a region surrounded by the annular joint portion 36, and is also smaller than a diameter D2 of the gas outflow port 30a.

As illustrated in FIG. 4, a surface 40 of the reinforcement plate 38 facing the propellant-side burst disk 35 has a stepped shape in which a central portion 40a protrudes more than a peripheral portion 40b.

As illustrated in FIG. 2, the reinforcement plate 38 configured as described above is press-fitted so that the outer peripheral surface side abuts against the inner peripheral surface of the end portion 3a of the bottle 3, and is fixed to the end portion 3a of the bottle 3 together with the housing 28 by laser welding or the like. In the assembled state, the reinforcement plate 38 is disposed such that the opening 39 thereof substantially concentrically overlaps the gas outflow port 30a, and the central portion 40a of the surface 40 facing the propellant-side burst disk 35 is inserted into the concave attachment seat 32 to be disposed close to the propellant-side burst disk 35.

According to the present embodiment, when the combustion gas is generated by ignition of the propellant, a central part of the propellant-side burst disk 35 receives the pressure of the combustion gas from the housing 28 side indicated by the arrow in FIG. 5, is inverted to the bottle 3 side from the state convex to the housing 28 side illustrated in FIG. 5, is pressed against a peripheral edge 41 of the opening 39 on the facing surface 40 (specifically, the central portion 40a thereof) of the reinforcement plate 38, and the propellant-side burst disk 35 is ruptured by the opening diameter of the opening 39 in the reinforcement plate 38.

Here, in order to increase the shock wave generated upon rupturing, it is necessary to increase the pressure (rupture pressure) on the housing 28 side necessary for rupture. For this purpose, it is effective to reduce an area of a pressure receiving surface of the propellant-side burst disk 35 on which the pressure of the combustion gas from the housing 28 side acts.

In a case in which the reinforcement plate 38 is not provided, the pressure receiving surface of the propellant-side burst disk 35 is a region surrounded by the annular joint portion 36 (diameter D1), whereas the pressure receiving surface of the propellant-side burst disk 35 in the present embodiment including the reinforcement plate 38 is a region corresponding to the opening 39 (opening diameter D3) in the reinforcement plate 38 having a smaller diameter than the region surrounded by the joint portion 36, and the area of the pressure receiving surface is smaller in the present embodiment. As a result, in the present embodiment, the rupture pressure is increased, and the shock wave generated upon rupturing can be increased.

Next, the gas discharge port portion 50 disposed on the other end (end portion 3b) side of the bottle 3 will be described.

The gas discharge port portion 50 includes a discharge port main body 51 and a flange portion 54 as a lid portion disposed on a base portion 51a side (bottle 3 side) of the discharge port main body 51 so as to close the other end (end portion 3b) side of the bottle 3.

The discharge port main body 51 has a bottomed hollow shape in which the base portion 51a side which is the bottle 3 side is opened (in the case of the present embodiment, a bottomed cylindrical shape in which a distal end 51b side is closed), and a plurality of discharge openings 52a capable of discharging the pressurized gas G are disposed in a peripheral wall 52. In the hybrid inflator 1 according to the present embodiment, a region on an inner peripheral surface side of the discharge port main body 51 constitutes a gas flow path 53.

In the case of the present embodiment, the flange portion 54 as a lid portion is formed integrally with the discharge port main body 51, and is formed in a flange shape so as to protrude outward from the base portion 51a side of the discharge port main body 51. A gas inflow port 54b is formed penetrating through the center of the flange portion 54 so as to be continuous with the gas flow path 53. In the present embodiment, the gas inflow port 54b is formed to be continuous with the gas flow path 53 with an inner peripheral surface thereof substantially aligned with an inner peripheral surface of the gas flow path 53. The flange portion 54 has a substantially circular plate-shaped outer shape and is fixed to the end portion 3b of the bottle 3 by laser welding or the like such that an outer peripheral surface 54a is press-fitted to the inner peripheral surface side of the other end (end portion 3b) of the bottle 3.

The discharge port-side burst disk 60 closes the gas inflow port 54b on the bottle 3 side, and is attached to an attachment seat 56 formed on a peripheral edge portion of the gas inflow port 54b on a base portion side end surface 55 which is the bottle 3 side in the flange portion 54 so as to close the gas inflow port 54b from the bottle 3 side. In the case of the present embodiment, the discharge port-side burst disk 60 is also made of a nickel-based alloy similarly to the propellant-side burst disk 35.

The hybrid inflator 1 according to the present embodiment configured as described above is electrically connected to a control device (not illustrated) disposed on a vehicle side, and is mounted on the vehicle together with an airbag (not illustrated). When mounted on the vehicle, upon receiving an operation signal from the control device (not illustrated), the squib 26 operates, the propellant 23 in the propellant storage portion 10 is combusted to generate the combustion gas, and the propellant-side burst disk 35 is ruptured by the generation of the combustion gas. Then, when the shock wave generated upon rupturing of the propellant-side burst disk 35 propagates in the bottle 3 and reaches the gas discharge port portion 50 side along with the increase in the internal pressure in the bottle due to the temperature rise of the pressurized gas G accompanying the rupture of the propellant-side burst disk 35, the discharge port-side burst disk 60 is ruptured, and the pressurized gas G filled in the bottle 3 flows out to the outside from the discharge opening 52a via the gas inflow port 54b and the gas flow path 53, thereby inflating the airbag (not illustrated).

As described above, according to the hybrid inflator 1 of the present embodiment, the reinforcement plate 38 disposed to face the propellant-side burst disk 35 is provided with the opening 39 having the opening diameter D3 smaller than the region (diameter D1) surrounded by the annular joint portion 36 and further smaller than the gas outflow port 30a (diameter D2), and the propellant-side burst disk 35 is ruptured by the opening diameter D3 of the opening 39. Therefore, as compared with the case in which the reinforcement plate 38 is not provided, the area of the pressure receiving surface of the propellant-side burst disk 35 on which the pressure of the combustion gas from the housing 28 side acts is reduced, and as a result, the rupture pressure is increased, and the shock wave generated upon rupturing can be increased. By propagating the increased shock wave to the gas discharge port portion 50, the discharge port-side burst disk 60 can be quickly ruptured. Therefore, in the hybrid inflator 1 according to the present embodiment, the pressurized gas G can be quickly discharged.

Further, in the hybrid inflator 1 according to the present embodiment, the propellant-side burst disk 35 is disposed in the step-down attachment seat 32 formed in the end surface 31 of the housing 28, and the surface 40 of the reinforcement plate 38 facing the propellant-side burst disk 35 has a stepped shape in which the central portion 40a protrudes more than the peripheral portion 40b. In this way, the assemblability of the propellant-side burst disk 35 to the housing 28 is improved, and the relative positions of the concave attachment seat 32 and the convex central portion 40a of the reinforcement plate 38 are adjusted by engagement therebetween, and therefore the assemblability of the reinforcement plate 38 can be improved. Further, since the central portion 40a of the reinforcement plate 38 can be disposed close to the propellant-side burst disk 35 disposed in the step-down attachment seat 32, when the combustion gas is generated, the central portion 40a of the reinforcement plate 38 can quickly abut against the propellant-side burst disk 35 disposed in the attachment seat 32 to rupture the propellant-side burst disk 35.

Although the embodiment of the present disclosure has been described in detail above, this is merely an example. For example, the size of the opening 39 provided in the reinforcement plate 38 can be appropriately changed within a range as long as the size of the opening 39 is smaller than the region (diameter D1 illustrated in FIG. 5) surrounded by the annular joint portion 36. The opening 39 and the annular joint portion 36 may have a non-circular shape such as a polygonal shape or an elliptical shape, and in this case, it is sufficient that the opening 39 has a smaller diameter than the annular joint portion 36 in terms of a diameter (equivalent circle diameter) of a circle having the same area as the area surrounded by the contour.

Further, in the above embodiment, welding is used for the joining (annular joint portion) between the propellant-side burst disk and the housing, but a method other than welding (for example, adhesion by an adhesive) can also be used. In addition, a method other than welding can be appropriately used for fixing the bottle and the reinforcement plate. 40 Further, in the above embodiment, the surface 40 of the reinforcement plate 38 facing the propellant-side burst disk 35 is formed in a stepped shape, but as illustrated in FIG. 7, for example, the entire surface 40 of the reinforcement plate 38 facing the propellant-side burst disk 35 can be formed of a flat surface, and the present invention can be implemented in variously modified modes without departing from the gist thereof.

What is claimed is:

1. A hybrid inflator comprising:
a bottle having a cylindrical shape and filled with a pressurized gas;
a propellant storage portion including a housing disposed on one end side of the bottle, and configured to store a propellant to be ignited in operation inside the housing, the propellant storage portion being partitioned from the bottle by a propellant-side burst disk configured to close a gas outflow port provided in the housing; and
a gas discharge port portion disposed on an other end side of the bottle to allow the pressurized gas to be discharged, the gas discharge port portion being partitioned from the bottle and closed by a discharge port-side burst disk, wherein
the propellant-side burst disk is joined at an annular joint portion to an end surface of the housing, the annular joint portion surrounding the gas outflow port, and
a reinforcement plate is disposed to face a surface of the propellant-side burst disk on a side opposite to the housing, the reinforcement plate having an opening smaller in diameter than a region surrounded by the annular joint portion.

2. The hybrid inflator according to claim 1, wherein
the opening of the reinforcement plate is smaller in diameter than the gas outflow port.

3. The hybrid inflator according to claim 1, wherein
the propellant-side burst disk is disposed in a step-down attachment seat formed on the end surface of the housing, and
a surface of the reinforcement plate facing the propellant-side burst disk has a stepped shape in which a central portion corresponding to the attachment seat of the housing protrudes.
